(19) United States
(12) Patent Application Publication
(10) Pub. No.: US 2014/0093144 A1
(43) Pub. Date: Apr. 3, 2014

(54) More-Secure Hardware Token

(71) Applicant: Dannie Gerrit Feekes, El Dorado Hills, CA (US)

(72) Inventor: Dannie Gerrit Feekes, El Dorado Hills, CA (US)

(21) Appl. No.: 14/043,784

(22) Filed: Oct. 1, 2013

Related U.S. Application Data
(60) Provisional application No. 61/708,236, filed on Oct. 1, 2012.
(60) Provisional application No. 61/708,515, filed on Oct. 1, 2012.

(51) Int. Cl. G06K 9/00

(52) U.S. Cl. CPC G06K 9/00087
USPC 382/124

(57) ABSTRACT

The present disclosure is generally directed to authenticating the identity of a user with a secure hardware token that stores the user's biometric data. The hardware token may perform a method of verifying the identity of a user which includes establishing a secure session with an interrogator device that obtained a scan of an unknown user's fingerprint. The hardware token then receives a representation of the obtained fingerprint image from the interrogator device. A fingerprint template associated with an authorized user is accessed from memory. Then, a comparison is performed between the fingerprint image received from the interrogator device and the fingerprint template associated with the authorized user.

### CROSS-REFERENCE TO RELATED APPLICATIONS

This application claims the benefit of the following provisional patent applications which are herein incorporated by reference: (1). Provisional Patent Application No. 61/708,236 filed on Oct. 1, 2012; and Provisional Patent Application No. 61/708,515 filed on Oct. 1, 2012.

### BACKGROUND

Growing security concerns have created a critical need to positively identify individuals as legitimate holders of credit cards, driver's licenses, passports, and the like. In this regard, new types of devices are being developed which have embedded integrated circuits and computer components that perform a variety of security related functions. These devices used for identification should be reliable, fast, relatively inexpensive, compact, portable, and robust for convenient use in a variety of environments, including airport security stations, customs and border crossings, police vehicles, point of sale applications, credit card and ATM applications, home and office electronic transactions, and entrance control sites. Importantly, these devices may need to securely store and communicate biometric data and protect against various types of exploits.

Biometrics is the use of biological or behavioral characteristics such as fingerprints, retina, voice, signature, keystroke patterns etc. that uniquely identifies a person. Among the different forms of biometrics, fingerprint-based identification is the most reliable and popular method and is currently applied in certain types of applications. The patterns formed by the lines or ridges that make-up a fingerprint are unique and immutable for each individual and can be reliably used for identification purposes. Fingerprint verification is most widely applied today in instances when a dedicated power source is available to power a device that processes a scan of a finger for comparison to a stored fingerprint image and/or template. In contrast, fingerprint verification has not been widely adapted and implemented in embedded applications where a dedicated power source is unavailable. For example, while there is a substantial incentive to perform biometric verification using a hardware token such as a “smartcard” to verify a consumer in a financial or other type of transaction, the demand for performing biometric verification in this context has gone unfulfilled. Providers have been unable to implement technology in an economically feasible way to perform biometric verification in this context. Accordingly, there is a need for an improved system, method, and devices for performing biometric verification in the context of these types of embedded applications.

### SUMMARY

This summary is provided to introduce a selection of concepts in a simplified form that are further described below in the Description. This summary is not intended to identify key features of the claimed subject matter, nor is it intended to be used as an aid in determining the scope of the claimed subject matter.

The present disclosure is generally directed to authenticating the identity of a user with a secure hardware token that stores the user's biometric data. The hardware token may perform a method of verifying the identity of a user which includes establishing a secure session with an interrogator device that obtained a scan of an unknown user's fingerprint. The hardware token then receives a representation of the obtained fingerprint image from the interrogator device. A fingerprint template associated with an authorized user is accessed from memory. Then, a comparison is performed between the fingerprint image received from the interrogator device and the fingerprint template associated with the authorized user.

### DESCRIPTION OF THE DRAWINGS

The foregoing aspects and many of the attendant advantages of the disclosed subject matter will become more readily appreciated as the same become better understood by reference to the following detailed description, when taken in conjunction with the accompanying drawings, wherein:

FIG. 1 is a block diagram depicting an exemplary environment where described embodiments of the disclosed subject matter can be implemented;

FIG. 2 is a general block diagram of an exemplary device in accordance with some embodiments of the disclosed subject matter;

FIG. 3 is a flow diagram of a routine for authenticating a user's biometric in accordance with some embodiments of the disclosed subject matter; and

FIG. 4 is a block diagram depicting an exemplary environment where described embodiments of the disclosed subject matter can be implemented.

### DESCRIPTION

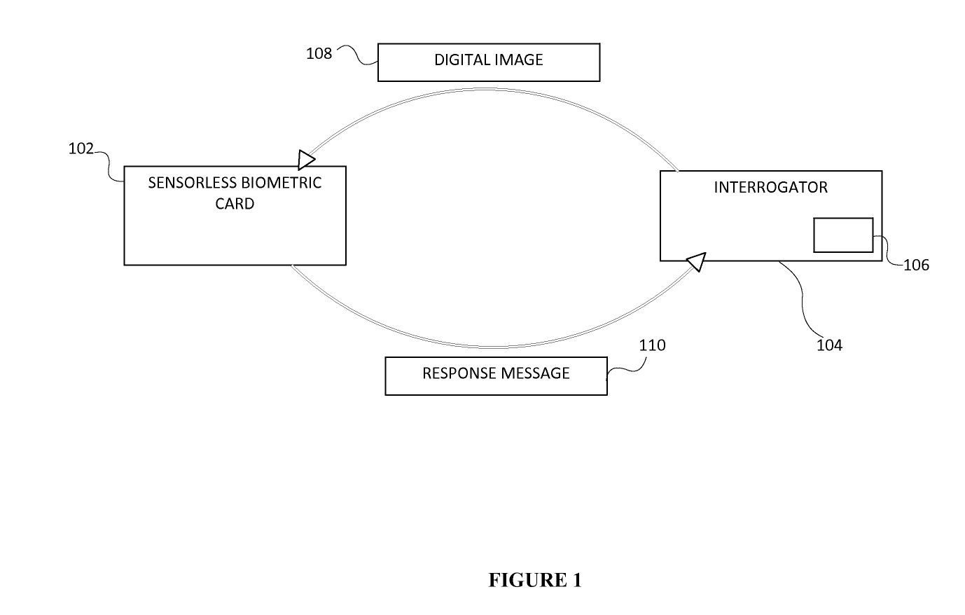

The present disclosure provides a system, method, and devices for performing biometric fingerprint authentication using a hardware token such as a “sensorless” biometric card and associated interrogator device. In one embodiment, the system 100 (FIG. 1) may include a hardware token that performs match-on-card of a fingerprint image. In the illustrated embodiment (FIG. 1), the hardware token may be a sensorless biometric card 102 that is configured to communicate with and coordinate functionality with an interrogator 104 which obtains a scan of the fingerprint image. In this regard, the interrogator 104 may be a point-of-sale terminal, a physical access device, or any other device configured to obtain a scan of a fingerprint image and communicate with the sensorless biometric card 102. As illustrated, the interrogator 104 includes a biometric fingerprint scanner 106 configured to perform a “live scan” of a finger and capture a digital image 108 or signal. While the fingerprint scanner 106 is illustrated in FIG. 1 as being an integrated component of the interrogator 104, the scanner 106 could be a standalone device that is communicatively coupled to the interrogator 104. In this instance, the scanner may connect to the interrogator 104 using a serial connection, USB port, and the like. The digital image 108 captured by the interrogator 104 and/or fingerprint template representing the distinctive characteristics of the fingerprint is then securely transmitted to the sensorless biometric card 102. Once received, the sensorless biometric card 102 performs a comparison between the received fingerprint data with corresponding data that is maintained on the biometric card 102. Accordingly, live scan data obtained by the interrogator 104 is compared to and used for validating fingerprint data associated with a specific user. Then, the sensorless biometric card 102 transmits a response message 110 to the interrogator 104 which provides an indicator regarding whether the identity of the user was validated. As described in further detail below, the response message 110 may include data such as a One Time Password (OTP) or a digital certificate that authenticates the possession of the hardware token if the user's identity was successfully authenticated.

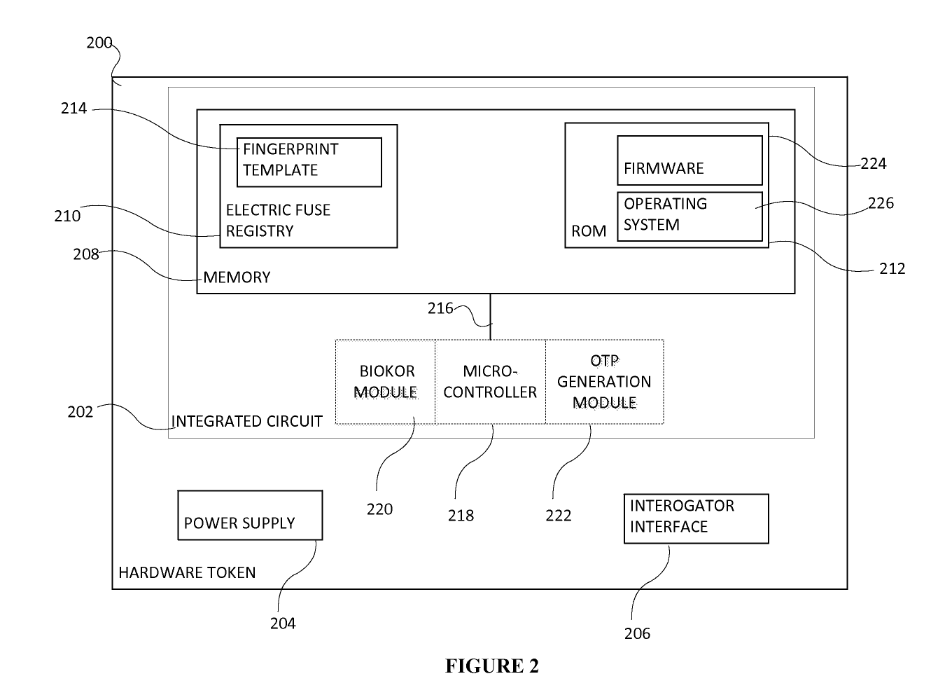

Now with reference to FIG. 2, an exemplary system architecture of a hardware token 200 in accordance with the present disclosure will be described. The sensorless biometric card described above with reference to FIG. 1 is just one example of a hardware token. As illustrated in FIG. 2, the hardware token 200 includes the integrated circuit 202, a power source 204, and an interrogator interface 206. As described above with reference to FIG. 1, the hardware token 200 is configured to communicate with an external source (i.e. the interrogator 104). It should be well understood that the hardware token 200 may be configured to communicate with the external source from the interrogator interface 206 in a number of different ways and using a variety of protocols. In one embodiment, the hardware token 200 is a contactless smart card that communicates with an external source from the interrogator interface 206 using wireless communication methods such as Near Field Communication (NFC), Bluetooth, and the like. Moreover, the hardware token 200 is configured to work with the existing contactless and contact-based “Card Present” payment and physical access infrastructure (ATM machines, point-of-sale (POS) readers, NFC physical readers, etc.) and the interrogator interface 206 includes the appropriate technology for interacting with the POS such as a magnetic stripe, an EMV chip, a QR code display, an NFC component and/or any other similar Card Present technology. Regardless of the communication method and in accordance with one embodiment, the present disclosure provides a secure method of exchanging data between the hardware token 200 and an external device (i.e. the interrogator 104) utilizing the interrogator interface 206.

In the embodiment illustrated in FIG. 2, the hardware token 200 includes the internal power supply 204 which may be comprised of a battery, super-capacitor, and/or piezo electric component. As will be clear in the description below, the hardware token 200 may include one or more active components that utilizes a specified amount of power. In instances when a certain amount of power is needed, the hardware token 200 may be configured with an internal power supply 204 that provides power to other components of the hardware token. In other embodiments, the hardware token 200 is configured without an internal power supply. In this instance, the hardware token 200 may be comprised of passive components that do not require an internal power source and/or power is obtained or otherwise harvested from an external source. By way of example, one skilled in the art and others will recognize that both contact (e.g. ISO/IEC 7810) and contactless (e.g. NFC) point-of-sale terminals may be utilized to supply power to the hardware token 200 when performing a transaction. Moreover, the hardware token 200 may also harvest energy from an external source utilizing a piezo electric effect. In some instances, the energy obtained from the external source is sufficient to power the hardware token 200 thereby negating the use of an internal power supply. In other instances, the energy harvested from the external source is used to supply power and recharge the internal power supply 204. In this instance, a smaller and more cost-effective internal power supply 204 would be sufficient to provide power to other components of the hardware token 200.

As further depicted in FIG. 2, the hardware token 200 further includes the integrated circuit 202 which may be any number of different types of circuits such as an ASIC (Application Specific Integrated Circuit), an FPGA (Field Programmable Gate Array), a System-on-Chip (SOC), or any other type of substantially similar chip package. In the exemplary embodiment depicted in FIG. 2, the integrated circuit 202 includes an internal non-volatile memory 208 comprised of the electric fuse registry 210 and the read-only memory (ROM) 212. While an Electric Fuse registry and ROM are depicted in FIG. 2, the non-volatile memory 208 may be comprised of other types of memory such as but not limited to EEPROM, flash memory, ferro-electric RAM (F-RAM), spin torque memory, magneto resistive RAM, or any other type of non-volatile memory.

Hackers exploit weak points or vulnerabilities in security to obtain unauthorized access to data. In one type of attack, so called “line sniffing” occurs where a hacker is able to monitor communications on a communication bus or subsystem that transfers data between components (i.e. processor, memory, etc.). It is well known in the art that computing components frequently communicate sensitive data which may or may not always be encrypted in transit. It is possible for a hacker to disassemble a computer system, for example, and ‘sniff’ sensitive data on a bus as data is passed from a micro-controller to a memory external to an integrated circuit.

In one aspect of the present disclosure, a more-secure way to store and communicate sensitive data, such as a fingerprint template or image, are provided. In conventional devices, sensitive data is typically stored in some type of memory module of the device where it is accessible to other computing components. The memory module may be an embedded non-volatile memory that has the capability to retain the stored data even when the device is not powered. Such a device is programmed or configured with certain data from the embedded non-volatile memory upon power up. Moreover, sensitive data has also been stored in external memory, solid state memory, and the like. In the embodiment of the present disclosure depicted in FIG. 2, the fingerprint template 214 is stored in the electric fuse registry 210. One skilled in the art will recognize that a fingerprint template is the name used to describe a stored file in a fingerprint scanning system. When a fingerprint is enrolled into the system, only a “template” of the fingerprint is stored, not an actual image of the fingerprint. Accordingly, a fingerprint template is a compressed representation of a fingerprint image and therefore utilizes fewer memory resources than would otherwise be used. In this regard and by way of example only, the compressed template implemented by the present disclosure may be compressed to 8 bytes×16 bytes×22 bytes which takes approximately 4 kilobytes in memory. When data corresponding to the sensitive data (i.e. the fingerprint template 214) is requested by another component of the integrated circuit 200, the data is transmitted across an internal bus to the requesting component. Unlike a bus that communicates data between an external memory and a processor or other computing components, unauthorized systems are unable to access the fingerprint template 214 either when stored or while in transit. While the descriptions provided herein are made with reference to storing and transmitting fingerprint data, other biometric information and/or sources may also be utilized (e.g. iris, heartbeat, hand print, voice, vein, etc.) and the descriptions provided herein should be construed as exemplary.

In one embodiment, an encrypted representation of the fingerprint template 214 is maintained in an electric fuse registry 210 of the non-volatile memory 208. In this regard, the data in the electric fuse registry 210 is represented by electrically burning a fuse link. Typically, a programmed fuse is assigned a logic value of 1 and a pristine fuse is assigned a logic value of 0 such that the bits are usually one-time programmable. In other words, data representing the fingerprint template 214 is ‘etched’ or ‘hard-coded’ onto the integrated circuit 202 and cannot be changed subsequently by a hacker or other unauthorized entity. By hard coding an encrypted representation of the fingerprint template 214 in the electric fuse registry 210 of the non-volatile memory 208, aspects of the present disclosure insure the integrity of the data representing the fingerprint template 214. Moreover, and in accordance with one aspect of the present disclosure, the fingerprint template 214 in the electric fuse registry 210 is either encrypted or otherwise encoded. One skilled in the art will recognize that this data may be encoded using any number of encoding schemes on only decoded using an external key. As a result of this scheme, the present disclosure provides enhanced security and would prevent a hacker from visually inspecting the die of the integrated circuit 202 and extracting data representing the fingerprint template 214.

A common way to secure a communication channel is by encrypting all the data sent over the channel using, for example, a public key infrastructure. However, in instances when an integrated circuit utilizes an external memory, a hacker can potentially intercept the encrypted data in transit between the chip package and the external memory thereby allowing the captured data to the target module whenever desired by the unauthorized user. With reference again to FIG. 2, another embodiment of the present disclosure in which the memory bus 216 is not exposed outside of chip packages is illustrated. In this embodiment, the integrated circuit 202 only utilizes the non-volatile memory 208 which is internal to the chip package. As a result, communication that occurs between the non-volatile memory 208 across the memory bus 216 to other components (such as the micro-controller 218) of the integrated circuit 202 are not exposed to possible ‘line sniffing’ attacks. Moreover, data transmitted across the memory bus 216 will preferable be both encrypted while maintained in the non-volatile memory 208 and while in transit across the memory bus 216. By maintaining the fingerprint template 214 in the electric fuse registry 210 and limiting communication of this sensitive data across the internal non-volatile memory 208, aspects of the present disclosure are able to both eliminate discrete components in a fingerprint scanning system and more securely manage sensitive data of interest to unauthorized users.

In the embodiment of the present disclosure depicted in FIG. 2, the integrated circuit 202 includes the micro-controller 218, the BioKor module 220, and the OTP generation module 222. As mentioned previously, incoming biometric data captured using an interrogator device is provided to the hardware token 200. In this regard, the hardware token 200 implements so-called ‘match-on-card’ functionality for authenticating the incoming fingerprint. In the embodiment illustrated in FIG. 2, the BioKor module 220 implements the image filtering and pattern matching logic that determines whether an incoming fingerprint image matches the fingerprint template 214. A more detailed explanation of a hardware-based biometric module (e.g. the BioKor module 220) suitable for being integrated into the micro-controller 218 can be found in the following commonly assigned, co-pending U.S. Patent Application No. 61/749,677 filed Jan. 7, 2013 entitled “MORE ROBUST DATA AND DEVICE SECURITY” which is incorporated herein by reference. In an alternative embodiment, a software-based biometric solution is implemented in the firmware 224 which may be maintained in the ROM 212. In this instance, software algorithms or routines that filter and authenticate the incoming fingerprint image are loaded into volatile memory (not illustrated) by the operating system 226 and executed by the micro-controller 218.

As briefly described above with reference to FIG. 1, the hardware token 200 returns data to the interrogator 104 which indicates whether the user was successfully authenticated. The fingerprint template 214 and a user's corresponding biometric data are not provided to an external device by the hardware token 200. To prevent spoofing of a successful authentication, aspects of the present disclosure may authenticate the possession of a specific hardware token by generating an OTP and/or providing a signed digital certificate to an interrogator. For example, only upon successfully authenticating a user's fingerprint may the OTP generation module 222 generate the OTP that is provided to the interrogator. As described in further detail below, the generated OTP may be subsequently forwarded to an authentication authority for further verification. While the embodiment in FIG. 2 depicts a OTP generation module 222 that is integrated with the micro-controller 218, the OTP generation logic may be implemented in the firmware 224 and in other ways than described without departing from the scope of the claimed subject matter.

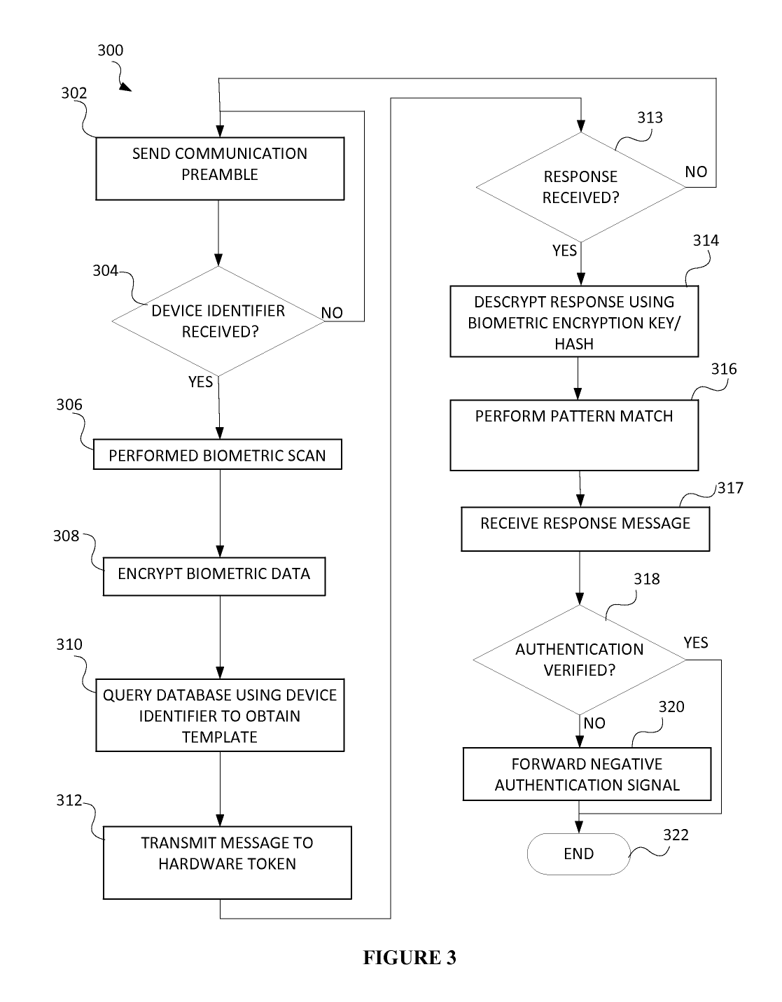

As mentioned previously, the present disclosure provides a secure method of exchanging data between the hardware token 200 and an external device (i.e. the interrogator 104). To securely authenticate the user and/or prevent exposing any of the authentication data, the present disclosure provides a communication protocol which enables the interrogator (e.g. POS terminal) to exchange encrypted data with the hardware token. An exemplary embodiment of a routine 300 that illustrates the communication protocol is illustrated in FIG. 3. In this regard, the routine 300 begins at block 302 where a communication preamble is transmitted from the hardware token to the interrogator. It will be appreciated by those skilled in the art that the hardware token and interrogator may utilize any number of different packet formats and communication systems when transmitting the communication preamble at block 302. Then, at block 304, the interrogator determines whether a device identification number associated with a specific hardware token was received. In certain instances, wireless and/or network communication may not be entirely reliable. Accordingly, a check is performed, at block 304, to determine whether an identifier associated with a specific hardware token was received. If a determination is made that the device identifier was not received, then the hardware token may retransmit the communication preamble periodically or may retransmit the communication preamble in response to a wake-up or polling signal received from the interrogator.

Once a determination is made, at block 304, that a specific identifier was received, then the routine 300 proceeds to block 306 where a biometric scan is performed that generates an image or data structure containing a description of a user's fingerprint. As mentioned previously and in accordance with one embodiment, an interrogator or associated device scans a finger and obtains a fingerprint image at block 306. To this end, the interrogator 104 includes a biometric fingerprint scanner 106 for capturing a digital image. Then, at block 308, the interrogator device encrypts the biometric data generated from the scan of the users' finger. One skilled in the art will recognize that any number of encryption algorithms/methods may be used to encrypt the biometric data, at block 308. Then, at optional block 310, the interrogator queries a local or remote database to obtain the biometric template associated with the user. In satisfying the database query, the device identifier obtained at block 302 may be used as a key to quickly search and obtain the appropriate fingerprint template from the database or other data store. As discussed further below, the fingerprint template obtained from the database, at optional block 310, should match the template maintained on the hardware token if the user is to be authenticated. Then, once the fingerprint template has been obtained, the interrogator transmits a message to the hardware token, at block 312. In one embodiment, the message transmitted at block 312 includes the biometric data obtained in the scan of the users' finger and a data hash key associated with the users fingerprint template which may be encoded and resident on the integrated circuit 202. Then, at block 313, the interrogator remains idle until a response message is received from the hardware token. If a response message is not received, the routine 300 proceeds back to block 302, and blocks 302-213 repeat until the interrogator receives a response message from the hardware token.

Upon receipt at the hardware token, the data transmitted by the interrogator, at block 312, is decrypted at block 314, using a variable and potentially unique “hashing” method or encryption/decryption key generated using attributes of the users fingerprint template. The data hash key transmitted by the interrogator, at block 312, enables the hardware token to read the sensitive data (fingerprint template 214) residing in protected memory (the electric fuse registry 210) and decrypt the fingerprint template, at block 314. With the fingerprint template decrypted, the hardware token may then identify the variable and potentially unique “hashing” method or encryption/decryption key used for encrypting the biometric data transmitted by the interrogator, at block 312. Since the hashing method and/or encryption key varies depending on attributes of users' fingerprint template, the actual encryption/decryption scheme implemented on the hardware token would be unique to an individual user. In other words, different hardware tokens will not implement the same hashing method and/or encryption keys nor will attributes of the hashing methods and/or encryption keys be transmitted between endpoints. The hashing method or encryption key generated from the fingerprint template will match the hashing method and/or encryption key implemented on the hardware token thereby facilitating a secure data exchange. Then, at block 316, a pattern match is performed in which the fingerprint image received from the interrogator is compared to the biometric data maintained on the hardware token. In instances when there is a match, the hardware token uses the biometric data resident natively on the card to identify the appropriate data hashing method and/or encryption keys. The hardware token then transmits the authentication data using the appropriate data hash/encryption key generated from the local fingerprint data to encrypt the data for transmission to the interrogator. Then, at block 317, the interrogator receives the response message from the biometric device and decrypts the message using the appropriate hashing method and/or encryption keys. As mentioned above, the decrypted message may include authentication data (such an OTP or digital certificate) generated by a specific hardware token. At decision block 318, a determination is made regarding whether the user has been authenticated. In instances when the user is authenticated, the hardware token provides the interrogator with a positive authentication signal and the transaction proceeds in accordance with existing systems. In instances when the user is not authenticated, the interrogator may forward a negative authentication signal to the appropriate financial network, at block 320, such that either the attempt to authenticate the user is repeated or the transaction is declined. Then, the routine 300 proceeds to block 322, where it terminates.

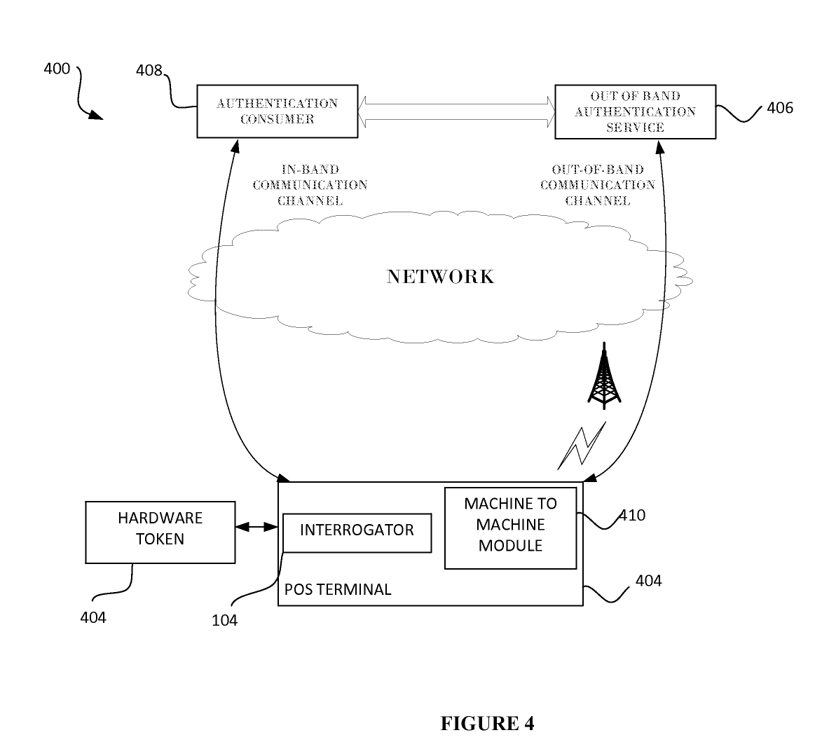

In the existing paradigm, a financial transaction request is processed by an interrogator device such as a POS, which connects to the appropriate financial network via an in-band communications channel on which the transaction is primarily conducted. A bank (or other service provider) who is required to debit and credit the payment and recipient bank accounts of the authorized participating parties is connected to the primary, in-band communication channel. In accordance with one embodiment, the present disclosure provides a system 400 (FIG. 4) for authenticating certain security credentials associated with a transaction via an out-of-band communication channel.

As depicted in FIG. 4, the system 400 of the present disclosure includes a POS terminal 402, a hardware token 404, and a mobile authentication authority 406. One skilled in the art will recognize that the POS terminal 402 depicted in FIG. 4 may be a standalone bank card terminal, a Personal Computer, a mobile device such as a tablet computer or mobile device, or any other device capable of communicating with the hardware token 404 as described herein. As mentioned above, a POS transaction may result in the POS terminal 402 being provided with an OTP digital certificate, or other security credential that verifies the possession of a specific hardware token 404 and/or successful biometric authentication. The POS terminal 402 may cause these credentials to be transmitted to the authentication consumer 408 via the in-band communication channel along with other transaction data (credit card number, name, address, etc.). However, in too many instances, a user's financial account information and security credentials communicated solely via the in-band communication channel have been stolen in transit or otherwise compromised. In accordance with one embodiment, the present disclosure causes certain security credentials such as a OTP or digital certificate to be transmitted from the POS terminal 402 to the authentication service 406 via an out-of-band communication channel. If the credentials transmitted across both the in-band and out-of-band communication channels are identified as genuine, then the transaction will typically be successful. One skilled in the art will recognize that the verification methods described herein are highly compatible with the existing in-band financial payment infrastructure.

In accordance with one embodiment, the system 400 of the present disclosure includes a POS terminal 402 that is configured to work with the existing “in-band” payment infrastructure and includes POS connectivity and interface technology that, for example, may comply with the UnifiedPOS standards of the National Retail Federation. However, the POS terminal 402 has multiple interfaces, including: a first interface for communicating with a financial network infrastructure via the in-band communication channel and a second interface that supports wireless communication on the out-of-band communication channel. While outside the scope of the present disclosure, the security credentials obtained from the hardware token 404 should be managed by the POS terminal 402 in a way that securely segregates and communicates this data on the out-of-band communication channel entirely separate from other aspects of the POS platform. In this regard, the POS terminal 402 includes a M2M module 410 operative to perform wireless communications across a cellular network. In one embodiment, the POS terminal 402 is configured to generate a SMS message that contains an OTP provided by the hardware token 404 for transmission to the network service 406. The M2M module 410 provides the transceiver circuitry for communicating the SMS message across the existing wireless infrastructure. However, the out-of-band communication may be performed in other ways than in an SMS message. In this regard, the out-of-band communication will typically be performed in a secure session such as in a USSD or SSL session.

While the preferred embodiment of the present disclosure has been illustrated and described, it will be appreciated that various changes can be made therein without departing from the spirit and scope of the disclosed subject matter.

1. A hardware token configured to perform a method of verifying the identity of a user, the method comprising:
establishing a secure session with an interrogator device that obtained a scan of an unknown user's fingerprint;
receiving a representation of the obtained fingerprint image from the interrogator device;
accessing a fingerprint template associated with an authorized user from memory on the hardware token;
performing a comparison, on the hardware token, between the fingerprint image received from the interrogator device with the fingerprint template associated with the authorized user; and
providing the integrator device a signal indicative of whether the identity of the user is verified.

2. The method as recited in claim 1, wherein the fingerprint template data is stored on the hardware token in an encrypted state and wherein a key transmitted by the interrogator is configured to decrypt the fingerprint template data.

3. The method as recited in claim 1, wherein the fingerprint template data is stored on the hardware token in an one-time writable non-volatile memory.
